(19) United States
(12) Patent Application Publication
(10) Pub. No.: US 2019/0336936 A1
(43) Pub. Date: Nov. 7, 2019

(54) QUANTUM DOT MANUFACTURING APPARATUS AND QUANTUM DOT MANUFACTURING METHOD

(71) Applicant: LAMINAR CO., LTD., Seongnam-si (KR)

(72) Inventors: Jong Pal HONG, Seongnam-si (KR); Gyeong Rye CHOI, Seongnam-si (KR); Myung Geun JONG, Seongnam-si (KR)

(73) Assignee: LAMINAR CO., LTD., Seongnam-si (KR)

(21) Appl. No.: 16/402,119

(22) Filed: May 2, 2019

(30) Foreign Application Priority Data
May 2, 2018 (KR) 10-2018-0050702

(51) Int. Cl. B01J 19/18; B01J 19/00; C09K 11/88

(52) U.S. Cl. CPC B01J 19/1862; B01J 19/1806; B82Y 20/00; C09K 11/883; B01J 2219/00132; B01J 19/0013

(57) ABSTRACT

The present invention relates to an apparatus and a method for preparation of quantum dots capable of continuously preparing quantum dots having uniform luminous properties using Taylor vortices. The apparatus for preparing quantum dots according to the present invention includes a first Couette-Taylor reactor for forming a core, core precursor sources each connected to the first Couette-Taylor reactor to supply a core precursor, a second Couette-Taylor reactor for forming a shell, and a shell precursor source connected to the second Couette-Taylor reactor to supply a shell precursor. In this case, the first and second Couette-Taylor reactors are connected to each other so that a core generated in the first Couette-Taylor reactor is supplied to the second Couette-Taylor reactor, and the apparatus further includes a temperature control means for keeping the internal temperature of each of the first and second Couette-Taylor reactors constant.

### TECHNICAL FIELD

The present invention relates to an apparatus for preparing quantum dots and a method of preparing quantum dots, and more particularly, to an apparatus and a method for preparation of quantum dots capable of continuously preparing quantum dots having uniform luminous properties using Taylor vortices.

### BACKGROUND ART

Quantum dots are nanometer-scale metal or semiconductor particles, usually composed of hundreds to thousands of atoms. In the early 1980s, a team led by Prof. Louis Brus of Columbia University discovered colloidal quantum dots. In 1993, a team led by Prof. Moungi Bawendi of MIT University developed an efficient wet synthesis method. Since then, research has been conducted on quantum dots using various materials such as cadmium (Cd), indium (In), and lead (Pb). In general, quantum dots exhibit intermediate properties between the physical properties of a single atom and the physical properties of a bulk material. In particular, quantum dots exhibit a characteristic wherein the band gap is inversely proportional to size due to quantum confinement effect of electrons confined in a small space. Based on these characteristics, since the energy structure can be controlled without changing the chemical composition, quantum dots can be applied to various fields such as solar cells, light emitting devices, photocatalysts, transistors, sensors, and bio-imaging devices.

In addition, since quantum dots are chemically synthesized inorganic substances, quantum dots have advantages such as low cost, long lifespan, and high color reproducibility as compared with organic light emitting diodes (OLEDs). Therefore, studies have been actively conducted on techniques for manufacturing photoelectric conversion devices such as solar cells and light emitting diodes using quantum dots.

There are various difficulties in mass production of quantum dots in industry. For example, one factor that affects the characteristics of quantum dots is the diameter of quantum dots. According to a solution reaction method known as the main preparation method of quantum dots, when preparing quantum dots in large quantities, it is difficult to uniformly control the diameter of quantum dots.

As a conventional method of preparing quantum dots, there is a hot injection method. In the hot injection method, a raw precursor solution is heated to a high temperature and injected to a surfactant solution to synthesize quantum dots. The hot injection method has been mainly used for preparation of small quantities of quantum dots. There are limitations in applying this method to preparation of large quantities of quantum dots. When scaling up for mass production, problems including increase in full width at half maximum (FWHM) due to generation of a temperature gradient inside a reaction solution and disappearance of the symmetry of a photoluminescence (PL) graph may occur.

Korean Patent No. 10-1084226 (Invention title: MULTIPLE COUETTE-TAYLOR VORTEX REACTOR) discloses a multiple Couette-Taylor vortex reactor in which multiple Couette-Taylor vortices are generated simultaneously inside and outside of a rotating cylinder by forming passages between the inside and outside of the cylinder so that fluid flow is communicated between the inside and outside of the cylinder, thereby improving space efficiency and efficiency of processes such as mixing, extraction, precipitation (crystallization), separation, culture, and chemical and biochemical reactions. According to this patent, the multiple Couette-Taylor vortex reactor includes an external fixed cylinder having an outlet at one end thereof; a rotary cylinder rotated by a driving motor and provided inside the external fixed cylinder so that a constant spacing is maintained therebetween while the one end of the external fixed cylinder with the outlet is blocked by a blocking wall and a passage is formed between the other end of the external fixed cylinder and the rotary cylinder; and an internal fixed cylinder provided inside the rotary cylinder so that a constant spacing is maintained therebetween, wherein an inlet is provided at one end of the internal fixed cylinder on the blocking wall side so as to be close to the blocking wall and the other end of the internal fixed cylinder is fixed to the external fixed cylinder.

Korean Patent No. 10-1275845 (Invention title: APPARATUS FOR PREPARING PRECURSOR OF CATHODE ACTIVE MATERIAL FOR LITHIUM SECONDARY BATTERY USING COUETTE-TAYLOR VORTICES) discloses an apparatus for preparing a precursor of a cathode active material for a lithium secondary battery using mixed metal salts using a co-precipitation method, including a Couette-Taylor reactor in which a reaction product containing precursor particles is generated by co-precipitation reaction in which reaction materials including a mixed metal salt solution and an alkali solution are added and stirred; a particle separator provided with a separation chamber connected to the Couette-Taylor reactor through a slurry supply pipe and a dispersion device for dispersing agglomerated particles of slurry including precursor particles supplied to the separation chamber through the slurry supply pipe, wherein precursor particles and fine particles dispersed by the dispersion device in the separation chamber are separated from each other; and a precipitator connected to the Couette-Taylor reactor through a waste solution discharge pipe and for cooling a waste solution discharged from the Couette-Taylor reactor through the waste solution discharge pipe to precipitate and remove alkali metal salts and then discharging the waste solution.

### DISCLOSURE

### Technical Problem

Therefore, the present invention has been made in view of the above problems, and it is one object of the present invention to provide an apparatus and a method for preparation of quantum dots capable of continuously preparing quantum dots having uniform luminous properties using Taylor vortices.

### Technical Solution

In accordance with one aspect of the present invention, provided is an apparatus for preparing quantum dots including a first Couette-Taylor reactor for forming a core; core precursor sources each connected to the first Couette-Taylor reactor to supply a core precursor; a second Couette-Taylor reactor for forming a shell; and a shell precursor source connected to the second Couette-Taylor reactor to supply a shell precursor, wherein the first and second Couette-Taylor reactors are connected to each other so that a core generated in the first Couette-Taylor reactor is supplied to the second Couette-Taylor reactor, and the apparatus further includes a temperature control means for keeping the internal temperature of each of the first and second Couette-Taylor reactors constant.

The temperature control means may be a heating jacket surrounding the outside of the Couette-Taylor reactor and supplying heat to the reactor.

In accordance with another aspect of the present invention, provided is a method of preparing quantum dots including (1) a core synthesis step of supplying a core precursor for forming a core to a first Couette-Taylor reactor and heat-treating the core precursor in Taylor vortices to synthesize a core; and (2) a shell synthesis step of supplying the synthesized core and a shell precursor to a second Couette-Taylor reactor and heat-treating the synthesized core and the shell precursor in Taylor vortices to synthesize a shell on the core, wherein the heat treatment is performed at a temperature within a temperature difference range of ±4° C. based on a core formation temperature or a shell formation temperature or both the core formation temperature and the shell formation temperature.

The heat-treatment may be performed at a temperature within a temperature difference range of ±2° C. based on a core formation temperature or a shell formation temperature or both the core formation temperature and the shell formation temperature.

### Advantageous Effects

As apparent from the foregoing, the present invention advantageously provides an apparatus and a method for preparation of quantum dots capable of continuously preparing quantum dots having uniform luminous properties using Taylor vortices.

### DESCRIPTION OF DRAWINGS

FIG. 1 is a schematic diagram showing the configuration of the apparatus for preparing quantum dots according to the present invention.

FIG. 2 is a schematic diagram showing the configuration of a Couette-Taylor reactor included in the apparatus for preparing quantum dots of FIG. 1.

FIG. 3 is a graph showing measurement results of the photoluminescence spectrum of the quantum dots prepared in Example 1.

FIG. 4 is a graph showing measurement results of the photoluminescence spectrum of the quantum dots prepared in Example 2.

FIG. 5 is a graph showing measurement results of the photoluminescence spectrum of the quantum dots prepared in Comparative Example 1.

FIG. 6 is a graph showing measurement results of the photoluminescence spectrum of the quantum dots prepared in Comparative Example 2.

FIGS. 7 to 9 are graphs each showing measurement results of the photoluminescence spectrum of the quantum dots prepared in Example 3.

FIGS. 10 to 12 are graphs each showing measurement results of the photoluminescence spectrum of the quantum dots prepared in Example 4.

### BEST MODE

Hereinafter, specific embodiments of the present invention will be described in detail with reference to the accompanying drawings.

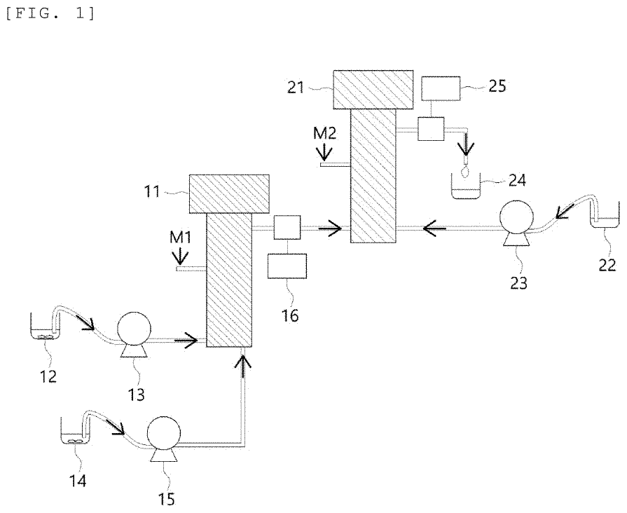

As shown in FIG. 1, the apparatus for preparing quantum dots according to the present invention includes a first Couette-Taylor reactor 11 for forming a core, core precursor sources 12 and 14 each connected to the first Couette-Taylor reactor to supply a core precursor, a second Couette-Taylor reactor 21 for forming a shell, and a shell precursor source 22 connected to the second Couette-Taylor reactor 21 to supply a shell precursor, wherein the first and second Couette-Taylor reactors and 21 are connected to each other so that a core generated in the first Couette-Taylor reactor 11 is supplied to the second Couette-Taylor reactor 21, and the apparatus further includes a temperature control means for keeping the internal temperature of each of the first and second Couette-Taylor reactors 11 and 21 constant.

That is, according to the present invention, when a core and/or a shell are synthesized in Taylor vortices, the core and the shell are separately synthesized using separate Couette-Taylor reactors. Accordingly, in forming the core and/or the shell, temperature may be precisely controlled, thereby enabling mass production of quantum dots and improving the luminous properties, i.e., full width at half maximum (FWHM), of the obtained quantum dots. That is, problems such as increase in full width at half maximum (FWHM) due to generation of a temperature gradient in a reaction solution and disappearance of the symmetry of a photoluminescence (PL) graph may be solved.

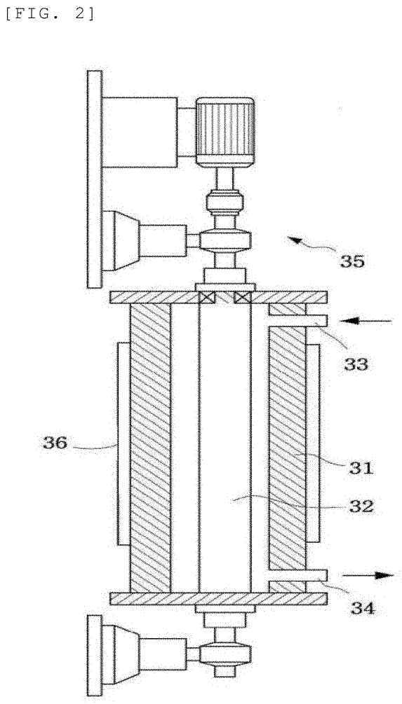

FIG. 2 shows the basic configuration of a Couette-Taylor reactor usable in the present invention, including the first Couette-Taylor reactor 11 for forming a core and the second Couette-Taylor reactor 21 for forming a shell. That is, the Couette-Taylor reactor is a reactor for generating a Taylor vortex flow. The Couette-Taylor reactor may be composed of a cylinder 31 and a rotary body 32, longitudinal central axes of which extend in the same direction, a precursor inlet 33, a product outlet 34, and an actuator 35 for rotating the rotary body 32 rotatably fixed in the cylinder 31. The cylinder 31 has a cylindrical shape extending in the horizontal direction. The rotary body 32 is rotatably fixed in the cylinder 31. The rotary body 32 may have a cylindrical shape extending in the same direction as the cylinder 31. The space between the inner wall of the cylinder 31 and the rotary body 32 may be defined as a reaction space in which a core is synthesized from a core precursor and a shell is synthesized from a shell precursor to form quantum dots. The reaction space is filled with a fluid (reaction solution). The cylinder 31 is a fixed member, and the rotary body 32 rotates about a horizontal axis in the cylinder 31. Upon rotating, the fluid adjacent to the rotary body 32 tends to flow toward the cylinder 31 by centrifugal force. As a result, Taylor vortices having a paired ring arrangement regularly rotating in opposite directions along the rotational axis direction of the rotary body 32 may be formed. Taylor vortices may be generated when the rotational speed of the rotary body 32 exceeds a threshold value. To rotate the rotary body 32, the rotary body 32 may be coupled to the actuator 35 disposed outside of the cylinder 31. The actuator 35 may be composed of an electric motor and a reduction gear assembly.

The temperature control means for keeping the internal temperature of each of the first and second Couette-Taylor reactors 11 and 21 constant may be a heating jacket 36 surrounding the outside of the Couette-Taylor reactor, i.e., the outside of the cylinder 31, and supplying heat to the cylinder 31. The heating jacket 36 is preferably an electric heating jacket using Joule heat.

The core precursor sources 12 and 14 are connected to the first Couette-Taylor reactor 11 to supply a core precursor. Depending on cores to be formed, one or more core precursor sources 12 and 14 may be provided. When two or more core precursor sources 12 and 14 are provided, a plurality of precursor inlets corresponding to the sources may be provided in the first Couette-Taylor reactor 11. However, in general, the first Couette-Taylor reactor 11 may be provided with one product outlet. The core precursor is introduced into the first Couette-Taylor reactor 11 from the core precursor sources 12 and 14, and a core is synthesized from the core precursor in the first Couette-Taylor reactor 11.

In addition, the shell precursor source 22 is connected to the second Couette-Taylor reactor 21 to supply a shell precursor for forming a shell. Depending on a shell to be formed, one or more shell precursor sources 22 may be provided. When two or more shell precursor sources 22 are provided, a plurality of precursor inlets corresponding to the sources may be provided in the second Couette-Taylor reactor 21. However, in general, the second Couette-Taylor reactor 21 may be provided with one product outlet.

The first and second Couette-Taylor reactors 11 and 21 are connected to each other so that, when a core formed in the first Couette-Taylor reactor 11 is discharged through the product outlet of the first Couette-Taylor reactor 11, the discharged core is directly supplied to the second Couette-Taylor reactor 21. Accordingly, in addition to the core discharged through the product outlet of the first Couette-Taylor reactor 11, a shell precursor is supplied to the second Couette-Taylor reactor 21 from the shell precursor source 22, and a shell is formed on the core therein. As a result, quantum dots having a double layer structure in which a shell is formed on a core are obtained.

As shown in FIG. 1, a core precursor contained in the core precursor sources 12 and 14 may be supplied to the first Couette-Taylor reactor 11 by the pushing action of pumps 13 and 15 respectively connected to the core precursor sources 12 and 14. The pumps are preferably liquid metering pumps.

In addition, a shell precursor contained in the shell precursor source 22 may be supplied to the second Couette-Taylor reactor 21 by the pushing action of a pump 23 connected to the shell precursor source 22.

In addition, the apparatus for preparing quantum dots according to the present invention may further include a measurement means for measuring luminous properties (i.e., full width at half maximum (FWHM) and symmetry of photoluminescence graph). For example, as shown in FIG. 1, a first detector 16 may be connected to the first Couette-Taylor reactor 11, and a second detector 25 may be connected to the second Couette-Taylor reactor 21. When quantum dots are successively prepared in the apparatus for preparing quantum dots according to the present invention, real-time quality control (QC) may be performed through measurement of luminous properties by the detectors. If measurement of the luminous properties of an intermediate product by the detectors is not performed, damaged materials may be synthesized, which increases preparation costs. Physical properties such as full width at half maximum (FWHM) and wavelength may be easily measured by attaching a flow cell to a photoluminescence measurement device and connecting the photoluminescence measurement device equipped with the flow cell to the outlet of the reactor.

In FIG. 1, reference number 24 represents a recovery container for recovering quantum dots obtained in the apparatus for preparing quantum dots according to the present invention. In addition, in FIG. 1, reference characters M1 and M2 denote temperature sensors, respectively.

In the apparatus for preparing quantum dots according to the present invention, the Couette-Taylor reactor is preferably operated at temperatures up to 300° C. In the case of conventional reactors, uneven synthesis occurs due to the temperature deviation of a reactor solution in a reactor, which makes scale up difficult. Therefore, in the apparatus of the present invention, besides raising the temperature of the reactor, it is important to control temperature deviation to within ±4° C., more preferably within ±2° C. A heating jacket is used to increase the temperature of the reactor of the present invention. In this case, the reactor may be heated up to 350° C. In addition, a thermal insulator is provided to minimize heat loss. Since temperature control is important at the moment of synthesis, the thermal insulator is formed to wrap the heating jacket from an injection region to an area where synthesis ends. When materials used to synthesize quantum dots are brought into contact with oxygen, problems such as occurrence of fire and failure of synthesis may occur. Thus, nitrogen or argon is injected. The reactor is made of stainless steel (steel type: SUS316L). In addition, to confirm results according to stirring speed, the reactor is formed to be capable of stirring at a speed of 100 to 1,500 rpm.

The method of preparing quantum dots according to the present invention includes (1) a core synthesis step of supplying a core precursor for forming a core to a first Couette-Taylor reactor and heat-treating the core precursor in Taylor vortices to synthesize a core; and (2) a shell synthesis step of supplying the synthesized core and a shell precursor to a second Couette-Taylor reactor and heat-treating the synthesized core and the shell precursor in Taylor vortices to synthesize a shell on the core, wherein the heat treatment is performed at a temperature within a temperature difference range of ±4° C. based on a core formation temperature or a shell formation temperature or both the core formation temperature and the shell formation temperature.

The core synthesis step (Step 1) is performed by supplying a core precursor for forming a core to a first Couette-Taylor reactor and heat-treating the core precursor in Taylor vortices to synthesize a core.

The shell synthesis step (Step 2) is performed by supplying the synthesized core and a shell precursor to a second Couette-Taylor reactor and heat-treating the core and the shell precursor in Taylor vortices to synthesize a shell on the core.

In particular, according to the present invention, in the core synthesis step (Step 1) and/or the shell synthesis step (Step 2), the heat treatment is performed at a temperature within a temperature difference range of ±4° C. based on a core formation temperature or a shell formation temperature or both the core formation temperature and the shell formation temperature. Through precise temperature control in this manner, luminous properties of the obtained quantum dots such as full width at half maximum (FWHM) and the symmetry of a photoluminescence graph may be improved. That is, problems including increase in full width at half maximum (FWHM) due to generation of a temperature gradient during reaction and disappearance of the symmetry of a photoluminescence graph may be solved. As a result, mass production of quantum dots may be realized.

The heat treatment is preferably performed at a temperature within a temperature difference range of ±2° C. based on a core formation temperature or a shell formation temperature or both the core formation temperature and the shell formation temperature.

The yield of quantum dots is determined by the concentration of a reaction solution and reaction time, and the reaction time is determined by the flow rate of the reaction solution to be injected. That is, if the concentration and the flow rate of a reaction solution are known, the yield of quantum dots can be determined by the following equation. Here, it is assumed that both Cd and Se participate in reaction.

C=M_{Cd}×MW_{Cd}+M_{Se}×MW_{Se}

C×Q=P, [Equation 1]

wherein C represents the sum of the concentration (g/ml) of Cd and the concentration (g/ml) of Se in a reaction solution; M_{Cd}, Mw_{Cd}, M_{Se}, and Mw_{Se} represent the molar concentration of Cd, the atomic weight of Cd (112.41 g/mol), the molar concentration of Se, and the atomic weight of Se (78.96 g/mol), respectively; Q represents the injection rate (ml/minute) of a reaction solution; and P represents the synthesis yield (g/hour) of quantum dots.

For example, if the concentration of Cd is 0.064 mmol/ml, and reaction time is 2 minutes, the yield of quantum dots is determined by the following calculation.

[Calculation]

0.064 mmol/ml×112.41 g/mol+0.008 mmol/ml×78.96 g/mol≈0.00782 g/ml

0.00782 g/ml×250 ml/min×60 min/h≈117.3 g/h

When reaction time is 2 minutes, the yield of quantum dots depending on the concentrations of each of Cd and Se is calculated and shown in Table 1.

TABLE 1

| Concentration | Cd | Se | Yield |
|---|---|---|---|
| (mmol/ml) | (g/ml) | (g/ml) | (g/h) |
| 0.064 | 0.0072 | 0.0006 | 117 |
| 0.128 | 0.0144 | 0.0012 | 234 |
| 0.192 | 0.0216 | 0.0019 | 352 |
| 0.256 | 0.0288 | 0.0025 | 469 |
| 0.320 | 0.0360 | 0.0031 | 586 |

Hereinafter, preferred examples and comparative examples of the present invention will be described.

The following examples are intended to explain the present invention and should not be construed as limiting the scope of the present invention.

### Example 1. Continuous Preparation of Quantum Dots

Quantum dots were continuously prepared using the apparatus for preparing quantum dots according to the present invention.

(1) Synthesis of Core Constituting Quantum Dot

35 ml of trioctylphosphine (TOP) and 20 mmol of Se were completely dissolved using a magnetic stirrer to prepare a Se precursor. 32 to 160 mmol of CdO and 30 to 150 ml of oleic acid (OA) were added to a three-neck flask, and then 1-octadecene (ODE) was added thereto to adjust the total volume to 500 ml. Vacuum was maintained at 120° C. for 30 minutes using a vacuum pump. Subsequently, atmosphere was replaced with a nitrogen atmosphere and heating was performed until CdO was completely dissolved. Thereafter, the solution was cooled to 40° C. to prepare a Cd precursor solution. Thus, through these processes, a Cd precursor solution and a Se precursor solution were prepared. In a first Couette-Taylor reactor, the atmosphere was replaced with nitrogen, and ODE was injected into the reactor using a liquid metering pump to remove oxygen and moisture. The reactor was heated to increase the temperature of the reactor to reaction temperature. Then, it was confirmed that temperature was stabilized. When the temperature was stabilized, injection of ODE was stopped, and the prepared Cd precursor solution and the prepared Se precursor solution were individually injected into the first Couette-Taylor reactor. In this case, the prepared Se precursor was injected into the reactor so that the molar ratio of Cd to Se was 8:1 to initiate reaction. In this case, to maintain temperature constant during injection, the temperature of an injection line was maintained at 40° C. using a hot wire. Core synthesis reaction was performed in Taylor vortices in the first Couette-Taylor reactor at 275° C.±4° C. for 1 to 2 minutes to prepare a core. The synthesized CdSe solution was washed using a centrifuge. The washed quantum dots were dispersed in toluene to analyze the luminous properties of the quantum dots.

(2) Synthesis of Quantum Dots (Step of Forming Shell on Core)

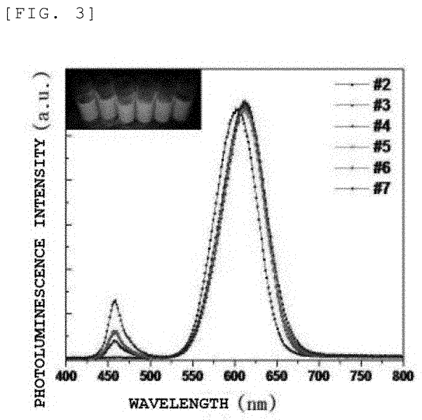

The core constituting a quantum dot synthesized in Step 1 was added to a second Couette-Taylor reactor, atmosphere of which had been replaced with nitrogen, and the temperature of the reactor was maintained at 225° C. 10 mmol of zinc diethyldithiocarbamate (ZnDDTC) dissolved in an oven set to 80° C. and 30 ml of TOP were injected into the second Couette-Taylor reactor and maintained for 30 minutes so that the weight ratio of Cd:Se:ZnDDTC was 16:2:1. Subsequently, the reactor was heated to 275° C.±4° C. and maintained for 30 minutes at the temperature to synthesize a shell. Then, the synthesized quantum dots were discharged from the second Couette-Taylor reactor and washed using a centrifuge. The washed quantum dots were dispersed in toluene to analyze the luminous properties of the quantum dots. The photoluminescence intensity with respect to the wavelength of the obtained quantum dots according to Example 1 is shown in FIG. 3. As shown in FIG. 3, it was confirmed that quantum dots were obtained at a satisfactory level. In addition to the emission wavelength region, the FWHM and the intensity of the photoluminescence spectrum were maintained constant. In FIG. 3, each curve represents the result of measuring photoluminescence with respect to sample acquisition time.

### Example 2. Continuous Preparation of Quantum Dots

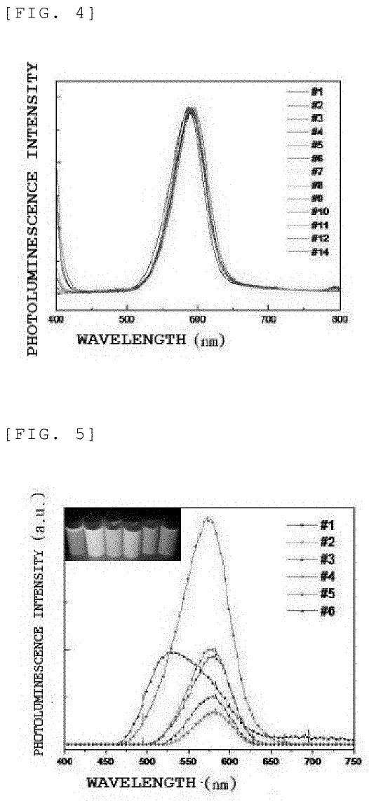

The same procedure as in Example 1 was performed, except that the temperature in the core synthesis step was maintained at 275° C.±2° C. and the temperature in the shell synthesis step was maintained at 275° C.±2° C. The photoluminescence intensity with respect to the wavelength of the quantum dots obtained according to Example 2 is shown in FIG. 4. As shown in FIG. 4, it was confirmed that quantum dots were obtained at a satisfactory level. In addition, it was confirmed that the intensity of the photoluminescence spectrum, the FWHM, and the emission wavelength region were maintained constant. In FIG. 4, each curve represents the result of measuring photoluminescence with respect to sample acquisition time.

### Comparative Example 1. Continuous Preparation of Quantum Dots

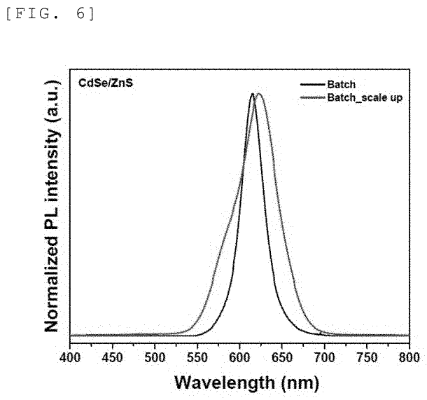

The same procedure as in Example 1 was performed, except that the temperature in the core synthesis step was maintained at 275° C.±10° C. and the temperature in the shell synthesis step was maintained at 275° C.±10° C. The photoluminescence intensity with respect to the wavelength of the quantum dots obtained according to Comparative Example 1 is shown in FIG. 5. As shown in FIG. 5, quantum dots were obtained, and no significant change was observed in the emission wavelength region over time. However, deviation was observed in the FWHM, and the intensity of the photoluminescence spectrum was continuously lowered. In FIG. 5, each curve represents the result of measuring photoluminescence with respect to sample acquisition time.

### Comparative Example 2. Batchwise Preparation of Quantum Dots (Hot Injection Method)

Quantum dots were prepared using a hot injection method, which is a general method of synthesizing quantum dots. Se was dissolved in a trioctylphosphine (TOP) solution to prepare a Se-containing TOP solution. Then, CdO was dissolved in a solution containing oleic acid (OA) and 1-octadecene (ODE) at a high temperature, and the prepared Se-containing TOP solution was added thereto to prepare a CdSe core. Subsequently, a solution prepared by dissolving zinc diethyldithiocarbamate (ZnDDTC) in TOP was added to the CdSe core to form a ZnS shell on the core to synthesize quantum dots.

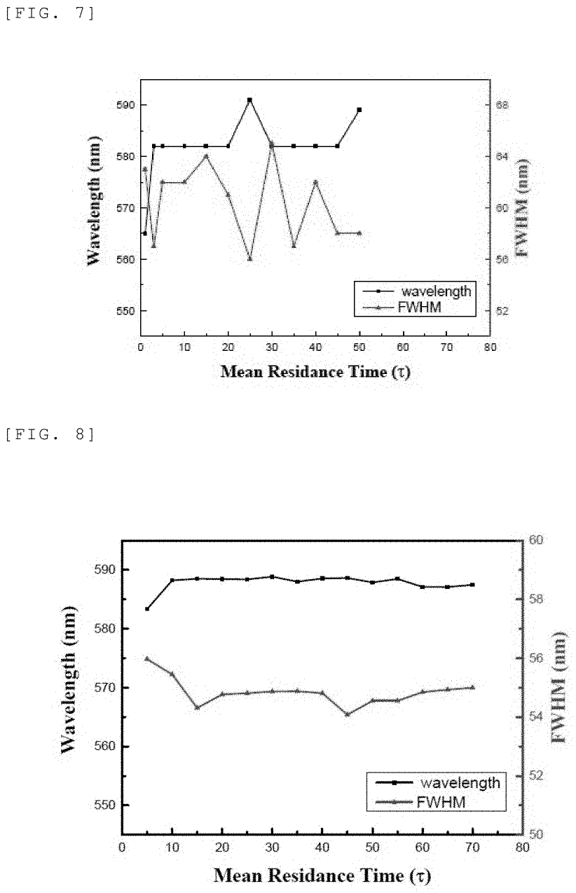

The hot injection method is mainly used to prepare small quantities of quantum dots having excellent properties. In Comparative Example 2, experiments on synthesis of small quantities of quantum dots were performed on the basis of preparation of 0.7 g of quantum dots in a 50 ml reactor. Scale-up experiments in quantum dot preparation were performed on the basis of preparation of 19.5 g of quantum dots in a 1,000 ml reactor. The photoluminescence spectrum of the quantum dots prepared batchwise according to scale-up was measured and is shown in FIG. 6. In FIG. 6, the black line represents the experiments on synthesis of small quantities of quantum dots performed on the basis of preparation of 0.7 g of quantum dots in a 50 ml reactor, and the red line represents scale-up experiments in quantum dot preparation performed on the basis of preparation of 19.5 g of quantum dots in a 1,000 ml reactor. As shown in FIG. 6, it was confirmed that, when quantum dots were synthesized in large quantities for mass production, the full width at half maximum (FWHM) increased due to a temperature gradient formed in a reaction solution and the symmetry of a photoluminescence graph was disappeared. These results indicate that the sizes of the synthesized quantum dots are not uniform. Therefore, it can be seen that the method according to Comparative Example 2 is not suitable for mass production of quantum dots.

### Example 3. Continuous Preparation of Quantum Dots with Different Reaction Times

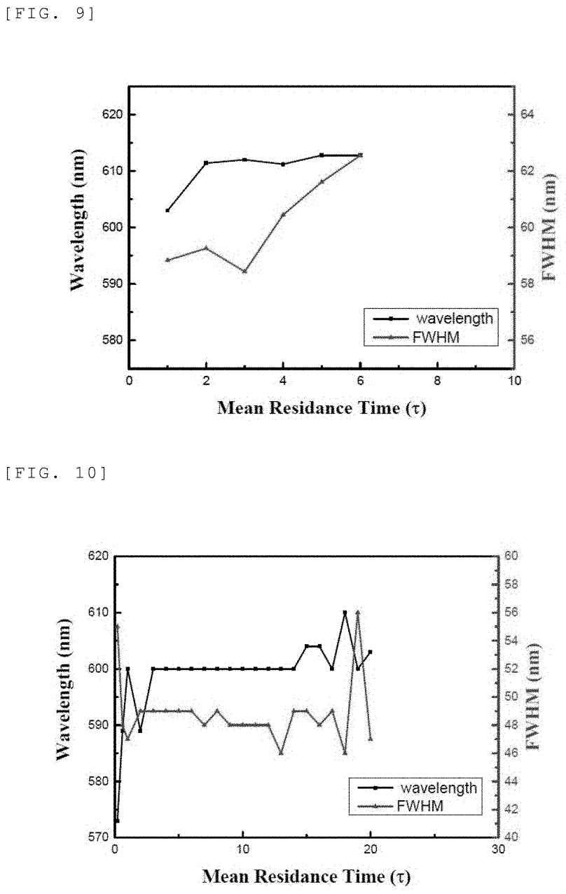

Quantum dots are synthesized and grown at a high temperature. In this case, as growth time is increased, the particle size increases and red shift of the emission wavelength increases. In addition, increase in the FWHM is observed. However, when injection is performed at a high speed to shorten growth time, it is difficult to control the temperature of a reactor and to maintain the temperature of the reactor constant. As a result, preparation of quantum dots having a uniform size may be difficult. The same method as in Example 1 was performed, except that synthesis of a core was performed at reaction times of 1 minute, 2 minutes, or 10 minutes (in the case of synthesis of a shell, reaction time was 10 minutes, the same as in Example 1). The wavelength changes were measured, and the results are shown in FIG. 7 (1 minute), FIG. 8 (2 minutes), and FIG. 9 (10 minutes). As shown in FIGS. to 9, it can be confirmed that the shortest reaction time to maintain temperature constant is 2 minutes, and the FWHM of a core is the smallest at the reaction time of 2 minutes.

### Example 4. Continuous Preparation of Quantum Dots with Different Stirring Speeds

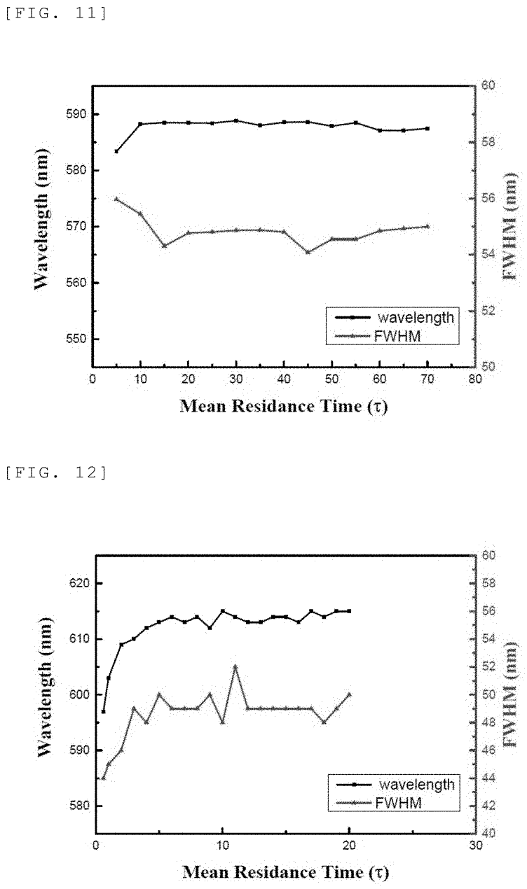

To investigate the influence of stirring speed on synthesis of quantum dots, the same procedure as in Example 1 was performed, except that stirring speed was set to 200 to 400 rpm, and the results are shown in FIGS. 10 to 12. As shown in FIG. 10 (200 rpm), FIG. 11 (300 rpm), and FIG. 12 (400 rpm), it can be confirmed that changes in the emission wavelength region and the full width at half maximum (FWHM) are significant at 400 rpm. In addition, it can be confirmed that the emission wavelength region and the full width at half maximum (FWHM) are stably maintained at 200 rpm, but the emission wavelength region and the full width at half maximum (FWHM) are greatly changed over time. On the other hand, it can be confirmed that changes in the emission wavelength region and the FWHM are the smallest at 300 rpm. These results suggest that the most suitable stirring speed for synthesis of quantum dots having a uniform size is 300 rpm.

Hereinafter, the present invention has been described in detail with reference to the preferred examples. However, these examples are provided for illustrative purposes only and should not be construed as limiting the scope and spirit of the present invention. In addition, it will be apparent to those skilled in the art that various changes and modifications may be made without departing from the spirit and scope of the present invention, and such changes and modifications are also within the scope of the appended claims.

### DESCRIPTION OF SYMBOLS

11: FIRST COUETTE-TAYLOR REACTOR
12, 14: CORE PRECURSOR SOURCES
13, 15: PUMPS
16: DETECTOR
21: SECOND COUETTE-TAYLOR REACTOR
22: SHELL PRECURSOR SOURCE
23: PUMP
24: RECOVERY CONTAINER
25: DETECTOR
M1: FIRST TEMPERATURE SENSOR
M2: SECOND TEMPERATURE SENSOR
31: CYLINDER
32: ROTARY BODY
33: PRECURSOR INLET
34: PRODUCT OUTLET
35: ACTUATOR
36: HEATING JACKET

1. An apparatus for preparing quantum dots, comprising:
a first Couette-Taylor reactor for forming a core;
core precursor sources each connected to the first Couette-Taylor reactor to supply a core precursor;
a second Couette-Taylor reactor for forming a shell; and
a shell precursor source connected to the second Couette-Taylor reactor to supply a shell precursor,
wherein the first and second Couette-Taylor reactors are connected to each other so that a core generated in the first Couette-Taylor reactor is supplied to the second Couette-Taylor reactor, and the apparatus further comprises a temperature control means for keeping internal temperature of each of the first and second Couette-Taylor reactors constant.

2. The apparatus according to claim 1, wherein the temperature control means is an electric heating jacket.

3. A method of preparing quantum dots, comprising:
(a) a core synthesis step of supplying a core precursor for forming a core to a first Couette-Taylor reactor and heat-treating the core precursor in Taylor vortices to synthesize a core; and
(b) a shell synthesis step of supplying the synthesized core and a shell precursor to a second Couette-Taylor reactor and heat-treating the synthesized core and the shell precursor in Taylor vortices to synthesize a shell on the core,
wherein the heat treatment is performed at a temperature within a temperature difference range of ±4° C. based on a core formation temperature or a shell formation temperature or both the core formation temperature and the shell formation temperature.

4. The method according to claim 3, wherein the heat-treatment is performed at a temperature within a temperature difference range of ±2° C. based on a core formation temperature or a shell formation temperature or both the core formation temperature and the shell formation temperature.
